(19) United States
(12) Patent Application Publication
(10) Pub. No.: US 2014/0030497 A1
(43) Pub. Date: Jan. 30, 2014

(54) LOCALIZED TRANSITIONAL COATING OF TURBINE COMPONENTS

(71) Applicants: Brian S. Tryon, Glastonbury, CT (US); David A. Litton, West Hartford, CT (US)

(72) Inventors: Brian S. Tryon, Glastonbury, CT (US); David A. Litton, West Hartford, CT (US)

(73) Assignee: UNITED TECHNOLOGIES CORPORATION, Hartford, CT (US)

(21) Appl. No.: 13/561,385

(22) Filed: Jul. 30, 2012

(51) Int. Cl. B32B 9/04; B32B 7/02; B32B 15/04

(52) U.S. Cl. 428/215; 428/697; 428/472; 428/332; 428/335

(57) ABSTRACT

Different thermal barrier coatings are deposited on different regions of the surface of a component. A first thermal barrier coating comprising an erosion resistant yttria stabilized zirconia material is deposited on a first region of the surface of the component. A second thermal barrier coating comprising an oxidation and corrosion resistant gadolinia stabilized zirconia is deposited on a second region of the surface of the component.

### BACKGROUND

This invention relates to thermal barrier coatings made from ceramic materials. The thermal barrier coatings have particular utility in gas turbine engines.

Gas turbine engines are well developed mechanisms for converting chemical potential energy, in the form of fuel, to thermal energy and then to mechanical energy for use in propelling aircraft, generating electrical power, etc. At this time, the major available avenue for improved efficiency of gas turbine engines appears to be the use of higher operating temperatures. However, the metallic materials used in gas turbine engines are currently very near the upper limits of the thermal stability. In the hottest portion of modern gas turbine engines, metallic materials are used at gas temperatures above their melting points. They survive because they are air cooled. However, providing air cooling reduces engine efficiency.

Accordingly, there has been extensive development of thermal barrier coatings for use with cooled gas turbine engine hardware. By using a thermal barrier coating (TBC), the amount of cooling air required can be substantially reduced, thus providing a corresponding increase in efficiency.

Such coatings are invariably based on ceramic materials. The current material of choice is zirconia modified with a stabilizer to prevent the formation of the monoclinic phase. Typical stabilizers include yttria, calcia, ceria, and magnesia.

Generally speaking, metallic materials have coefficients of thermal expansion which exceed those of ceramic materials. Consequently, one of the problems that must be addressed in the development of successful thermal barrier coatings is to match the coefficient of thermal expansion of the ceramic material to the metallic substrate so that upon heating, when the substrate expands, the ceramic coating material does not crack. Zirconia has a high coefficient of thermal expansion and this is a primary reason for the success of zirconia as a thermal barrier material on metallic substrates. In addition, the high fracture toughness of yttria stabilized zirconia coatings resist impact erosion in the hot gas path during operation. Zirconia stabilized with 7 wt. % yttria (7 YSZ) is a TBC of choice in many applications.

Gadolinia stabilized zirconia is an additional thermal barrier cooling material that is used to advantage due to its low thermal conductivity.

Despite the success with thermal barrier coatings, there is a continuing desire for improved coatings with improved insulative capabilities. Emphasis on strategic placement of different coatings on different regions of the same component can improve operating efficiency and durability as well as decrease cost.

### SUMMARY

A component requiring thermal protection utilizes different thermal barrier coatings on different regions of the surface of the component. A first thermal barrier coating may be used on a first region requiring erosion protection and comprises an erosion resistant yttria stabilized zirconia material containing from about 1 to about 25 wt. % yttria and the balance zirconia. A second thermal barrier coating may be used on a second region of the component requiring oxidation and corrosion protection. The second thermal barrier coating material comprises gadolina stabilized zirconia containing from about 5 to about 99 wt. % gadolinia and the balance zirconia.

In an embodiment, a thermal barrier coating system consists of a superalloy substrate having a surface and a bond coat with thermally grown oxide layer on the surface. A first thermal barrier coating on a first region of the surface with a first boundary may offer protection against erosion. The first thermal barrier coating comprises yttria stabilized zirconia containing from about 1 to about 25 wt. % yttria and the balance zirconia. A second thermal barrier coating on a second region of the surface with a second boundary different from the first region may offer protection against oxidation and corrosion. The second thermal barrier coating comprises gadolinia stabilized zirconia containing from about 5 to about 99 wt. % gadolinia and the balance zirconia.

### BRIEF DESCRIPTION OF THE DRAWINGS

FIG. 1 is a perspective view of a turbine blade.

FIG. 2A is a schematic cross section of a single layer embodiment of the invention.

FIG. 2B is a schematic cross section of another single layer embodiment of the invention.

FIG. 3 is a schematic cross section of a turbine blade.

FIG. 4 is a schematic cross section of a multilayer embodiment of the invention.

FIG. 5 is a schematic cross section of a multilayer embodiment of the invention.

FIG. 6 is a schematic cross section of a multilayer embodiment of the invention.

### DETAILED DESCRIPTION

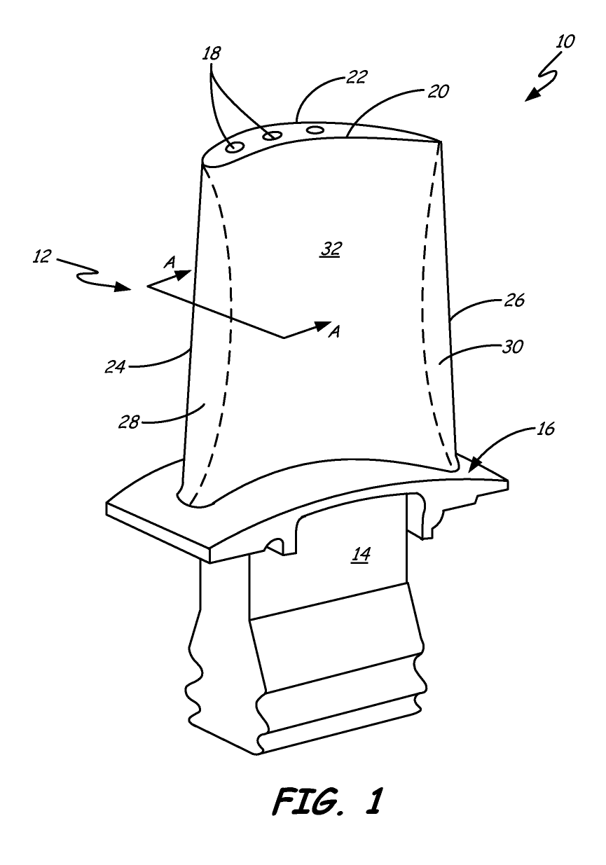

FIG. 1 shows a perspective view of turbine blade 10 that benefits from the protection offered by the present invention. Turbine blade 10 includes airfoil 12, blade root 14, and platform 16. During operation, airfoil 12 is exposed to a hot gas path and requires protection against particle erosion, oxidation, and corrosion. Such protection is offered by the thermal barrier coatings of the present invention as well as by air flowing through cooling holes 18 in airfoil 12, which are shown in the tip of airfoil 12 but may be located at various regions of airfoil 12 as well as platform 16.

The protection required by thermal barrier coatings (TBC' s) is regionally specific because of the different forms of damage experienced by different regions of a component in the gas stream. The different regions of airfoil 12 are pressure side 20, suction side 22, leading edge 24, and trailing edge 26. Particle erosion rate is highest at the leading and trailing edges in regions 28 and 30, respectively. Oxidation and corrosion are predominant on the mid-span regions 32 of pressure side 20 and suction side 34 (not shown) of airfoil 12.

While the present invention is illustrated in FIG. 1, as a turbine blade, the present invention may also be applied to vanes, supports, and other components exposed to the hot gas path. As such, the present invention is not intended to be limited to any particular component.

Thermal barrier coatings are employed to insulate and protect turbine components from the hot gas in the engine. They are typically ceramic layers deposited on an intermediate bond coat or protective thermally grown oxide coating that enhances thermal barrier coating adhesion and interdiffusion of oxygen and other elements between the thermal barrier coating and the substrate. Substrates may be any turbine alloy known in the art including nickel base, cobalt base, and iron base superalloys, titanium alloys, steels, copper alloys, and combinations thereof.

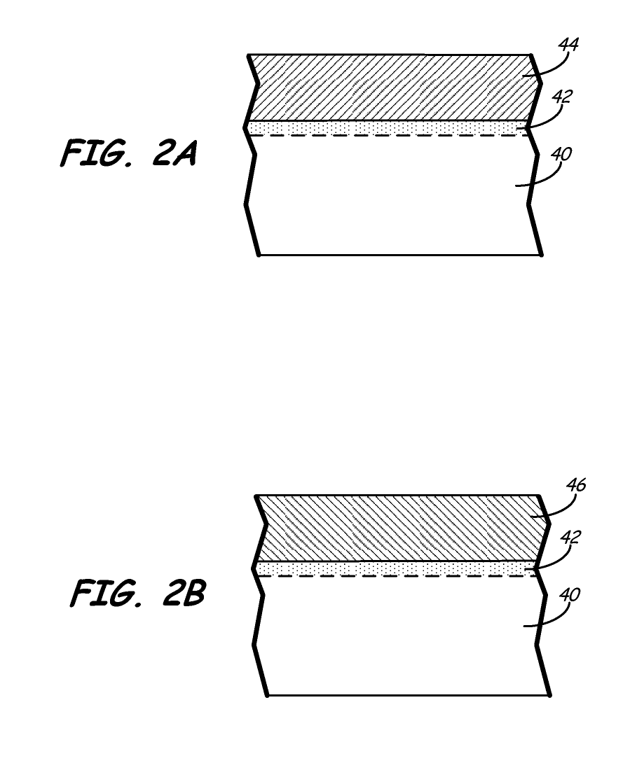

FIG. 2A is a schematic cross section of a thermal barrier system comprising substrate 40, optional bond coat and/or thermally grown oxide coating 42 and ceramic thermal barrier layer 44. Optional bond coat layer 42 may comprise a coating containing aluminum. The composition of this metallic coating is chosen such that a continuous, thin, slow growing aluminum oxide layer forms on the metal bond coat during operation. This aluminum oxide is universally known in the art as a thermally grown oxide or TGO. Typically metal bond coat layers 42 include MCrAlY alloys wherein M may be nickel, cobalt, iron, platinum, or mixtures thereof. The coatings can be deposited by air plasma spray, low pressure plasma spray, cathodic arc, and other techniques known in the art. Bond coat materials may also include (Ni, Pt) Al coatings formed by electroplating Pt then vapor coating NiAl and diffusion heat treating to form (Ni, Pt) Al. In the absence of a metal bond coat layer, a TGO layer forms between the metallic substrate 40 and ceramic layer 44. For systems with metallic bond coat layers, the TGO layer forms between the metallic bond coat layer and the thermal barrier coating.

These bond coat materials may be applied by any method capable of producing a dense, uniform, adherent coating of the desired composition, such as, but not limited to, an overlay bond coat, diffusion bond coat, cathodic arc bond coat, etc. Such techniques may include, but are not limited to, diffusion processes (e.g. inward, outward, etc.), low pressure plasma spray, air plasma spray, sputtering, cathodic arc, electron beam physical vapor deposition, high velocity plasma spray techniques (e.g. HVOF, HVAF), combination processes, wire spray techniques, laser beam cladding, electron beam cladding, etc. The thickness of the bond coat may be between 0.1 to 20 mils.

Ceramic thermal barrier coating 44 may have a zirconia base to which has been added at least one of the following elements: La, Ce, Pr, Nd, Sm, Eu, Gd, Tb, Dy, Ho, Er, Tm, Yb, Lu, Sc, In, Y, Mo, and C, rare earth oxides, scandium and indium, wherein the elements are present from 1-50 mol % of the M₂O₃ oxide where M refers to the listed elements.

A preferred TBC is yttria stabilized zirconia containing from about 1.0 to about 25 wt. % yttria and the balance zirconia. A more preferred material is zirconia containing 7 wt. % yttria (7 YSZ), as defined in commonly owned U.S. Pat. No. 4,321,311 and incorporated herein by reference in its entirety. As mentioned above, a distinguishing feature of yttria stabilized zirconia, in general, and 7 YSZ in particular, is the fracture toughness and impact and erosion resistance of the material. The thickness of the yttria stabilized zirconia TBC may be from about 0.25 to 3 mils.

Ceramic thermal barrier coating 44 may be applied to substrate 40 and optional intermediate bond coat and/or thermally grown oxide layer 42 by a variety of processes. Such processes include, but are not limited to, thermal spray processes such as an air plasma spray (APS), low pressure plasma spray (LPPS), high velocity oxygen fuel processes (HVOF), by detonation guns (DGun), sputtering, and other methods known in the art. A preferred method of depositing ceramic thermal barrier coating 44 involves electron beam physical vapor deposition (EBPVD). Use of EBPVD offers certain advantages as use of EBPVD develops a structure suitable for coating hot section turbine components. Thermal spray processing offers the advantage of coating large components of complex shape and is more suitable for coating components such as combustors.

FIG. 2B is a schematic cross section of a single layer thermal barrier coating system comprising substrate 40, optional bond coat and/or thermally grown oxide layer 42 and alternate ceramic thermal barrier layer 46. Alternate thermal barrier layer 46 may be an oxidation and corrosion resistant layer formed from at least one oxide of a material selected from the group consisting of Al, Ce, Pr, Nd, Pr, Sm, Eu, Gd, Tb, Dy, Ho, Er, Th, Y, Lu, Sc, In, Zr, Hf, and Ti. Alternatively, alternate thermal barrier layer 46 may be formed from a gadolinia stabilized zirconia.

Gadolinia stabilized zirconia offers superior thermal protection as well as oxidation and corrosion protection to superalloy and ceramic substrates. It has been observed that the GdZr material reacts with fluid sand deposits in the gas stream and forms a reaction product that inhibits fluid sand penetration into the coating. The reaction product has been identified as being a silicate oxyapatite/garnet material containing primarily gadolinia, calcia, zirconia, and silica. The gadolinia stabilized zirconia material may contain from about 5.0 to about 99 wt. % gadolinia, preferably 40-70 wt. % gadolinia (40-70 GdZr). The thickness of the gadolinia stabilized zirconia layer may be from about 0.25 to about 20 mils.

The different types of protection offered by 7 YSZ and 40-70 GdZr coatings form a basis of this invention. By coating different regions of a component, such as airfoil 12 of turbine blade 10, to offer protection against different environmental attack in different regions in the gas stream, component lifetime is enhanced over components protected by single monolithic coating systems.

At least four separate regions of airfoil 12 are candidates for the different coatings of the invention. These are, at least, leading edge region 28, trailing edge region 30, pressure mid-span region 32 of pressure side 20 and midspan region 34 of suction side 22 (not shown). Depending on operation requirements and required resistance to the environmental threat for each region, each of the four regions may be protected by at least one of a different coating.

If two protective coating candidates are considered, such as 7 YSZ and 40-70 GdZr, for example, there are sixteen possible permutations of coating. For instance, leading edge region 28 and trailing edge region 30 may be protected against particle erosion by 7 YSZ coatings and mid-span pressure side region 32 and mid-span suction side region 34 (not shown) areas may be protected against oxidation and molten sand or CMAS deposition by 40-70 GdZr coatings. In another example, trailing edge region 30 and mid-span region of pressure side 20 may be required to be protected against oxidation and molten sand and CMAS deposition. In that case, trailing edge region 30 as well as mid-span region 32 may require 40-70 GdZr coating.

Larger or smaller areas of each region may be protected with at least two types of thicknesses of thermal barrier coatings. The coating may be deposited using masking means to clearly define the boundaries of each coated region. In another embodiment, the boundaries between different coating types may be graded and intentionally diffuse. Regionally graded coating compositions can be achieved, for instance, by directionally dependent deposition methods such as thermal spray.

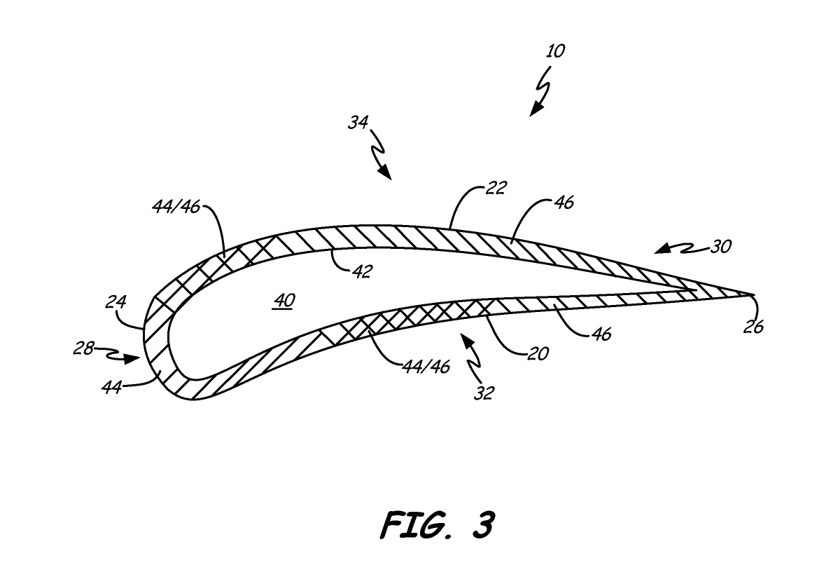

An example of the different types of protection offered by different coatings to different regions of a component according to the invention is shown in FIG. 3. FIG. 3 is a schematic cross section of airfoil 12 taken along plane AA shown in FIG. 1. In the embodiment, leading edge region 28 is protected against erosion by yttria stabilized zirconia, preferably 7 YSZ, coating 44. 7 YSZ coating 44 is deposited on substrate 40 and optional bond coat/thermally grown oxide layer 42 as shown. Midspan suction side region 34 and midspan pressure side region 32 are partially covered by gadolinia stabilized zirconia, preferably 40-70 GdZr, coating 46 offering protection against oxidation and corrosion. The regions between leading edge 24 and midspan suction side region 34 and leading edge 24 and midspan pressure side region 32 are transitional regions coated with graded concentrations of 7 YSZ coating 44 and 40-70 GdZr coating 46 as shown by cross hatching in the figure. In this embodiment, thermal protection as well as oxidation and corrosion protection in the regions coated with 40-70 GdZr coating 46 were considered to be important in the example shown.

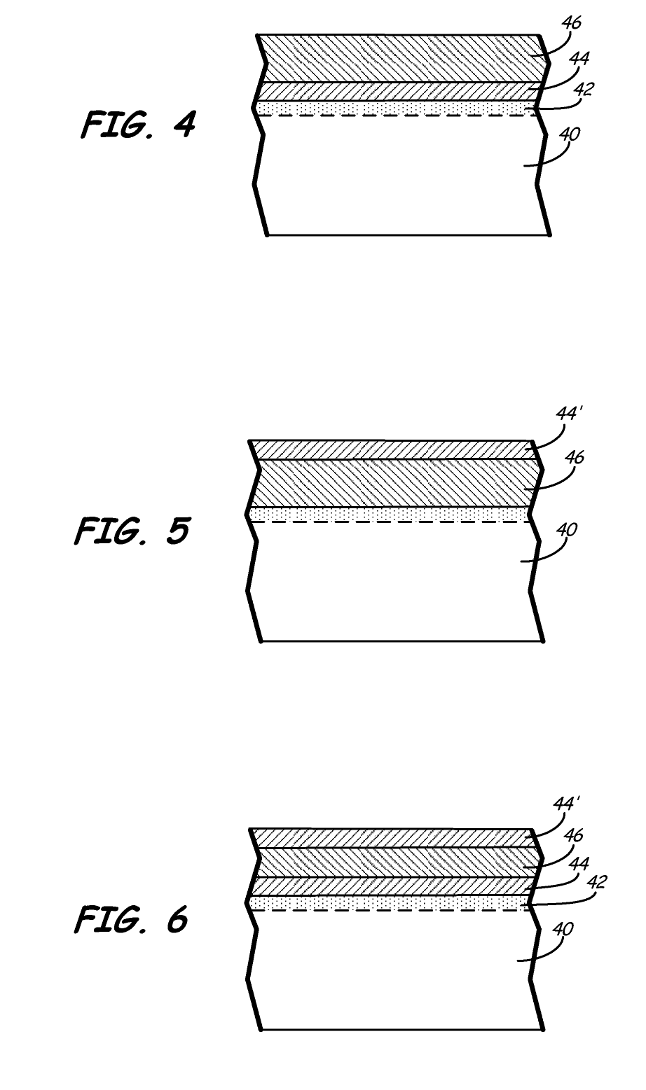

Referring to the coating systems in FIG. 2A and 2B, as “single layer” thermal barrier coating systems, an embodiment of the invention is shown in FIG. 4, in which the coating system is termed a “duplex” multilayer thermal barrier coating system. In FIG. 4, substrate 40 and optional bond coat/thermally grown oxide coating 42 are coated with ceramic bond coat layer 44 and thermal barrier layer 46 wherein thermal barrier layer 46 may be 40-70 GdZr. Ceramic bond coat layer 44 may be 7 YSZ which exhibits high fracture toughness that allows it to withstand the thermal stresses generated when metallic substrate 40, to which it is attached, is thermally cycled thereby enhancing adhesion of thermal barrier layer 46 to substrate 40. In this embodiment, thermal barrier layer 46 may be 40-70 GdZr, although the yttria stabilized zirconia and gadolinia stabilized zirconia compositions are not limited to those mentioned. Based on the aforementioned, the duplex TBC of FIG. 4 will exhibit superior oxidation and corrosion protection in the gas path by virtue of 40-70 GdZr outer layer 46.

In the above discussion, two coating types, 7 YSZ and 40-70 GdZr were applied to four possible locations; leading edge region 28, trailing edge region 30 pressure side mid-span region 32, and suction side mid-span region 34 resulting in sixteen possible combinations. If more than one coating type is deposited in any of the component regions, the number of possible iterations of even this simple coating configuration increases accordingly.

An embodiment is shown in FIG. 5 in which substrate 40 and optional bond coat/thermally grown oxide layer 42 are coated with gadolinia stabilized zirconia, preferably 40-70 GdZr layer 46 which is, in turn, coated with an yttria stabilized zirconia, preferably 7 YSZ top coat layer 44′. The erosion resistant 7 YSZ top coat layer 44′ provides added mechanical abrasion protection to underlying insulative and oxidation resistant 40-70 GdZr layer 46. The embodiment shown in FIG. 5 is referred to as “reverse duplex” TBC.

An embodiment is shown in FIG. 6 in which the “duplex” TBC structure of FIG. 4 is further coated with top coat layer 44′ of erosion resistant yttria stabilized zirconia, preferably, 7 YSZ. 7 YSZ top coat layer 44′ offers additional mechanical protection to insulative and corrosion resistant 40-70 GdZr layer 46 and mechanically connective 7 YSZ layer 44 between substrate 40 and optional bond coat/thermally grown oxide coating 42 and 40-70 GdZr layer 46.

The coating of the present invention is an advantageous thermal barrier coating system that selectively resists more than one type of environmental threat over different regions of the surface of a single turbine component. By tailoring the protective coating in each region of the surface to the specific type of threat directed at that particular region during service, component lifetime and system cost can be optimized. The areal and multilayer combinations and materials described herein are presented as examples and are not to be considered limiting to the range of thermal protection possibilities offered to turbine components by the present invention.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### DISCUSSION OF POSSIBLE EMBODIMENTS

The following are non-exclusive descriptions of possible embodiments of the present invention.

A component can include a substrate with a surface; a first thermal barrier coating on a first region of the surface, wherein the first thermal barrier coating is an erosion resistant material consisting of yttria stabilized zirconia containing from about 1 to about 25 wt. % yttria and the balance zirconia; and a second thermal barrier coating on a second region of the surface different from the first region, wherein the second thermal barrier coating is an oxidation and corrosion resistant material consisting of gadolinia stabilized zirconia containing from about 5 to about 99 wt. % gadolinia and the balance zirconia.

The component of the preceding paragraph can optionally include, additionally and/or alternatively any, one or more of the following features, configurations and/or additional components:

a substrate formed of a material selected from the group consisting of a nickel base superalloy, cobalt base superalloy, iron base superalloy, steel, titanium base alloy, copper base alloy, or combinations thereof;

the surface of the substrate can include at least one of a bond coat or a thermally grown oxide layer between the first and second thermal barrier coatings in the substrate surface;

the bond coat can be formed from a material selected from the group consisting of a MCrAlY coating, where M is Ni, Co, Fe, Pt, or combinations thereof, an aluminide coating, a platinum aluminide coating, and combinations thereof;

an yttria stabilized zirconia intermediate layer containing from about 1 to about 25 wt. % yttria and the balance zirconia with a thickness of from about 0.25 to about 3 mils it can be between the bond coat and the second thermal barrier coating;

a third thermal barrier coating comprising yttria stabilized zirconia containing from about 1 to about 25 wt. % yttria and the balance zirconia with a thickness of from about 0.25 to 3 mils can be formed overlaying the second thermal barrier coating;

the substrate can be in the form of an airfoil, and the first region of the surface can be located in one or more of a pressure side region, a suction side region, a leading edge region, and a trailing edge region;

the substrate can be in the form of an airfoil, and the second region of the surface can be located in one or more of a pressure side region, a suction side region, a leading edge region, and a trailing edge region;

the first thermal barrier coating can be 7 YSZ and the second thermal barrier coating can be 40-70 GdZr;

the thickness of the first thermal barrier coating can be from about 0.25 to about 3 mils and the thickness of the second thermal barrier coating can be from about 0.25 to about 20 mils.

A thermal barrier coating system can be a superalloy substrate with a surface and a bond coat with a thermally grown oxide layer on the surface; a first thermal barrier coating on a first region of the surface with a first boundary where the first thermal barrier coating is an erosion resistant material consisting of yttria stabilized zirconia containing from about 1 to about 25 wt. % yttria and the balance zirconia; and a second thermal barrier coating on a second region of the surface with a second boundary different from the first region where the second thermal barrier coating consists of an oxidation and corrosion resistant material consisting of gadolinia stabilized zirconia containing from about 5 to about 99 wt. % gadolinia and the balance zirconia.

The system of the preceding paragraph can optionally include, additionally and/or alternatively any, one or more of the following features, configurations, and/or additional components:

the superalloy can be formed of a material selected from the group consisting of nickel base superalloy, cobalt base superalloy, iron base superalloy, steel, titanium base alloy, copper base alloy, or combinations thereof;

the bond coat can be formed from a material selected from the group consisting of a MCrAlY coating wherein M is Ni, Co, Fe, Pt, or combinations thereof, an aluminide coating, a platinum aluminide coating, and combinations thereof;

an yttria stabilized zirconia intermediate layer containing from about 1 to about 25 wt. % yttria and the balance zirconia with a thickness of from about 0.25 to about 3 mils can be between the bond coat and the second thermal barrier coating;

a third thermal barrier coating comprising yttria stabilized zirconia containing from about 1 to about 25 wt. % yttria and the balance zirconia and a thickness of from about 0.25 to about 3 mils can be formed overlaying the second thermal barrier coating;

a compositional interface between the first and second boundaries can be a transitional region;

the first region of the surface can be located in one or more of a pressure side region, a suction side region, a leading edge region, and a trailing edge region;

the second region of the surface can be located in one or more of a pressure side region, a suction side region, a leading edge region, and a trailing edge region;

the first thermal barrier coating can be 7 YSZ and the second thermal barrier coating can be 40-70 GdZr;

the thickness of the first thermal barrier coating can be from about 0.25 to about 3 mils and the thickness of the second thermal barrier coating can be from about 0.25 to about 20 mils.

1. A component comprising:
a substrate with a surface;
a first thermal barrier coating on a first region of the surface, wherein the first thermal barrier coating comprises an erosion resistant material comprising yttria stabilized zirconia containing from about 1 to about 25 wt. % yttria and the balance zirconia; and
a second thermal barrier coating on a second region of the surface different from the first region, wherein the second thermal barrier coating comprises an oxidation and corrosion resistant material comprising gadolinia stabilized zirconia containing from about 5 to about 99 wt. % gadolinia and the balance zirconia.

2. The component of claim 1, wherein the substrate is formed of a material selected from the group consisting of a nickel base superalloy, cobalt base superalloy, iron base superalloy, steel, titanium base alloy, copper base alloy or combinations thereof.

3. The component of claim 1, wherein the surface of the substrate includes at least one of a bond coat or a thermally grown oxide layer between the first and second thermal barrier coatings and the substrate.

4. The component of claim 3, wherein the bond coat is formed from a material selected from the group consisting of a MCrAlY coating, where M is Ni, Co, Fe, Pt or combinations thereof, an aluminide coating, a platinum aluminide coating, and combinations thereof.

5. The component of claim 3, wherein an yttria stabilized zirconia intermediate layer containing from about 1 to about 25 wt. % yttria and the balance zirconia with a thickness of from about 0.25 to about 3 mils is between the bond coat and the second thermal barrier coating.

6. The component of claim 1, wherein a third thermal barrier coating comprising yttria stabilized zirconia containing from about 1 to about 25 wt. % yttria and the balance zirconia and a thickness of from about 0.25 to about 3 mils is formed overlaying the second thermal barrier coating.

7. The component of claim 1, wherein the substrate is in the form of an airfoil, and wherein the first region of the surface is located in one or more of a pressure side region, a suction side region, a leading edge region, and a trailing edge region.

8. The component of claim 1, wherein the substrate is in the form of an airfoil, and wherein the second region of the surface is located in one or more of a pressure side region, a suction side region, a leading edge region, and a trailing edge region.

9. The component of claim 1, wherein the first thermal barrier coating is 7 YSZ and the second thermal barrier coating is 40-70 GdZr.

10. The component of claim 1, wherein the thickness of the first thermal barrier coating is from about 0.25 to about 3 mils and the thickness of the second thermal barrier coating is from about 0.25 to about 20 mils.

11. A thermal barrier coating system comprising:
a superalloy substrate with a surface and a bond coat with a thermally grown oxide layer on the surface;
a first thermal barrier coating on a first region of the surface with a first boundary wherein the first thermal barrier coating comprises an erosion resistant material comprising yttria stabilized zirconia containing from about 1 to about 25 wt. % yttria and the balance zirconia; and
a second thermal barrier coating on a second region of the surface with a second boundary different from the first region wherein the second thermal barrier coating comprises an oxidation and corrosion resistant material comprising gadolinia stabilized zirconia containing from about 5 to about 99 wt. % gadolinia and the balance zirconia.

12. The thermal barrier coating system of claim 11, wherein the superalloy is formed of a material selected from the group consisting of nickel base superalloy, cobalt base superalloy, iron base superalloy, steel, titanium base alloy, copper base alloy, or combinations thereof.

13. The thermal barrier coating system of claim 11, wherein the bond coat is formed from a material selected from the group consisting of a MCrAlY coating wherein M is Ni, Co, Fe, Pt, or combinations thereof, an aluminide coating, a platinum aluminide coating, and combinations thereof.

14. The thermal barrier coating system of claim 11, wherein an yttria stabilized zirconia intermediate layer containing from about 1 to about 25 wt. % yttria and the balance zirconia with a thickness of from about 0.25 to about 3 mils is between the bond coat and the second thermal barrier coating.

15. The thermal barrier coating system of claim 11, wherein a third thermal barrier coating comprising yttria stabilized zirconia containing from about 1 to about 25 wt. % yttria and the balance zirconia and a thickness of from about 0.25 to about 3 mils is formed overlaying the second thermal barrier coating.

16. The thermal barrier coating system of claim 11, wherein a compositional interface between the first and second boundaries is a transitional region.

17. The thermal barrier coating system of claim 11, wherein the first region of the surface is located in one or more of a pressure side region, a suction side region, a leading edge region, and a trailing edge region.

18. The thermal barrier coating system of claim 11, wherein the second region of the surface is located in one or more of a pressure side region, a suction side region, a leading edge region, and a trailing edge region.

19. The thermal barrier coating system of claim 11, wherein the first thermal barrier coating is 7 YSZ and the second thermal barrier coating is 40-70 GdZr.

20. The thermal barrier coating system of claim 11, wherein the thickness of the first thermal barrier coating is from about 0.25 to about 3 mils and the thickness of the second thermal barrier coating is from about 0.25 to about 20 mils.
